(19) United States
(12) Patent Application Publication
(10) Pub. No.: US 2011/0253747 A1
(43) Pub. Date: Oct. 20, 2011

(54) DISPENSING TOOL FOR MULTI-COMPONENT SUBSTANCES

(75) Inventors: David Tobler, Winterthur (CH); Michael Schlumpf, Stallikon (CH); Manuel Buck, Gebenstorf (CH); Dana Maiwald, Zurich (CH)

(73) Assignee: SIKA TECHNOLOGY AG, Baar (CH)

(21) Appl. No.: 13/161,120

(22) Filed: Jun. 15, 2011

Related U.S. Application Data
(63) Continuation of application No. PCT/EP2009/067537, filed on Dec. 18, 2009.

(30) Foreign Application Priority Data
Dec. 18, 2008 (EP) 08172173.0

(51) Int. Cl. B67D 7/78; B65B 3/04

(52) U.S. Cl. 222/144.5; 141/2; 222/135; 222/333; 222/334

(57) ABSTRACT

A dispensing tool is disclosed which includes an exchangeable container having a main component A, a container having a minor component B, a mixer for the components A and B, and an expelling device for at least one of the containers, the expulsion into the mixer of at least one of the components being controllable independently of the other components. In addition, a method is disclosed for refilling the container of the minor component B of a dispensing tool.

### RELATED APPLICATION

This application claims priority as a continuation application under 35 U.S.C. §120 to PCT/EP2009/067537, which was filed as an International Application on Dec. 18, 2009 designating the U.S., and which claims priority to European Application 08172173.0 filed in Europe on Dec. 18, 2008. The entire contents of these applications are hereby incorporated by reference in their entireties.

### FIELD

The disclosure relates to a dispensing tool, such as a dispensing tool which include an exchangeable container with a main component and a container with a minor component, a mixer for the components and at least one expelling device for at least one of the containers.

Furthermore, the disclosure relates to a method for refilling of a container, such as the container of the minor component of a dispensing tool.

### BACKGROUND INFORMATION

Dispensing tools for multicomponent substances are known from applications for distribution of pasty substances such as for example adhesives, sealants and similar materials. These dispensing tools can be made either as portable hand tools or for certain applications as two-pump systems, such as piston metering systems.

Dispensing tools draw the main and minor components for example from an exchangeable disposable set having a container for the main component and a container for the minor component. As such, the disposable set can be thrown away when one of the two components is used up, as a result of which the remaining component cannot be further used. The choice of minor component is also limited to the one contained in the disposable set. Furthermore a considerable amount of waste can be formed in this system by the disposable use.

Another possibility for delivering the minor component in portable dispensing tools is a mixer attachment which contains the minor component. The contained minor component is mixed by the mixer attachment into the main component which is discharged by the dispensing tool. These mixer attachments are made as disposable products and are replaced when the type of main component is changed to prevent contamination with the preceding main component. The minor component which remains in the replaced mixer attachment thus cannot be further used. Furthermore, the mixer attachment due to its double function, mixer and container for the minor component, has a complex construction and is accordingly expensive to produce. Furthermore these mixer attachments are often unable to change the amount of the minor component which has been mixed in. Mixer attachments which are able to do this are technically complex to produce and are expensive, especially for disposable products.

Two-pump systems, such as piston metering installations, are costly and labor-intensive in procurement and maintenance. Furthermore they have large dead volumes, take up much space and cannot be integrated into a hand device with reasonable effort.

### SUMMARY

A dispensing tool is disclosed comprising: an exchangeable container for a main component A and a container for a minor component B; a mixer for the components A and B; and at least one expelling device for at least one of the containers, for regulating expelling of at least one of the components A or B into the mixer independently of the other component B or A.

A method is also disclosed for refilling the container of a minor component B of a dispensing tool having an exchangeable container for a main component A and a container for a minor component B; a mixer for the components A and B; and at least one expelling device for at least one of the containers, for regulating expelling of at least one of the components A or B into the mixer independently of the other component B or A, the method comprising: a) placing a container N which serves as the container for minor component B at a site provided for the container of the main component A; b) expelling a minor component B from the container N into an access to the container of the minor component B; and c) filling the container of the minor component B with minor component B via the access, the minor component B being expelled from the container N in step b) by the expelling device of the main component A.

### BRIEF DESCRIPTION OF THE DRAWINGS

Exemplary embodiments of the disclosure are detailed below using the drawings. The same elements in the different figures are provided with the same reference numbers. The flow direction of the media is indicated with arrows.

FIG. 1 shows a schematic of an exemplary dispensing tool;

FIG. 2 shows a further schematic of an exemplary dispensing tool;

FIG. 3 shows a schematic of refilling of an exemplary container of a minor component B;

FIG. 4 shows a schematic of a device for refilling of an exemplary container of the minor component B before and during refilling; and

FIG. 5 shows a schematic of an exemplary filling station for refilling of the container of the minor component B.

Only exemplary elements important for direct understanding of the disclosure are shown.

### DETAILED DESCRIPTION

An improved dispensing device is disclosed wherein, for example, expulsion of at least one of the components into the mixer can be regulated regardless of the other component.

By regulating the expulsion, the properties of the mixture of main component and minor component can be varied. Furthermore technically simple mixers can be used which need not ensure the regulation of the mixing amount or of the mixing pressure.

It is especially feasible if the expulsion of the minor component can be regulated by a metering unit which is located between the container of the minor component and the mixer. This can allow great flexibility in the choice of the amount and the type of minor component used.

The container of the main component can be emptied more quickly than the container 4 with the minor component, as a result of which the latter will be changed and/or filled less often. In this way the user of the dispensing tool acquires the ease of operation of a single-component system.

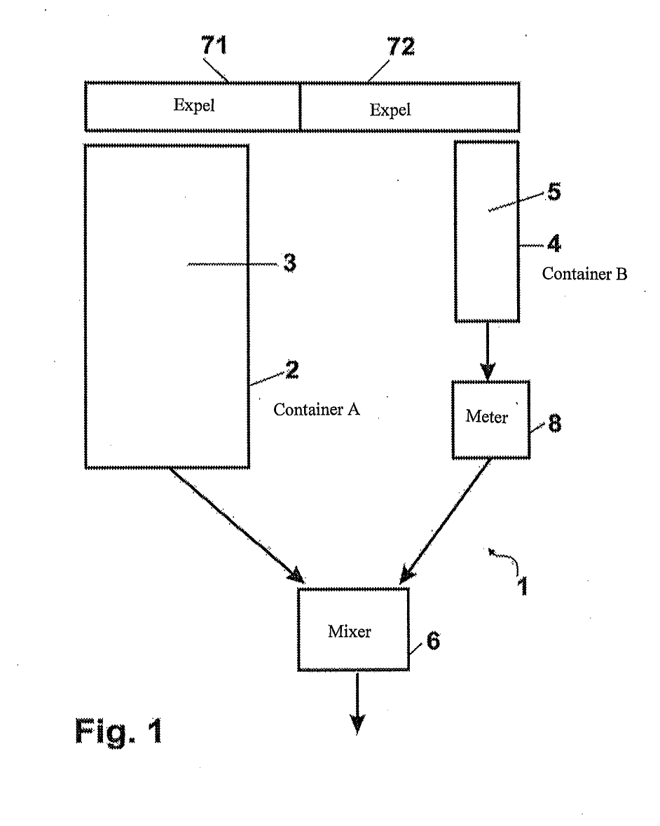

FIG. 1 schematically shows an exemplary dispensing tool 1. This dispensing tool 1 comprises an exchangeable container 2 with a main component A labeled 3 and a container 4 with a minor component B labeled 5. The dispensing tool 1 comprises a mixer 6 for the components A 3 and B 5, as well as at least one expelling device 71, 72 for at least one of the containers, and the expulsion of at least one of the components 3, 5 into the mixer 6 can be regulated independently of the other component 3, 5.

The regulation of the expulsion of one component into the mixer 6 allows, among other features, the generation of an expulsion pressure which corresponds roughly to the expulsion pressure of the other component. This can prevent penetration of one component into the container of another.

Furthermore the regulation of expulsion allows regulation of the expulsion amount of the components, for example the amount of minor component B 5 into the mixer 6 with reference to the amount of the main component A 3 into the mixer 6. As such, the properties of the mixture of A and B can thus be varied. Furthermore this allows the use of technically simple mixers which need not ensure the regulation of the mixing amount or of the mixing pressure of the minor component B 5.

The ratio of the volume of the minor component B 5 to the volume of the main component A 3 is, for example, 1:2-1:100, especially 1:10-1:90, preferably, for example, 1:40-1:75. The smaller volume of the minor component B compared to the main component A can be advantageous in that the minor component B thus can use less space, weight and energy for expulsion.

Furthermore the exchangeable container 2 with the main component A 3 can be emptied, for example, 0.5-30, preferably, for example, 3-20, especially 5-12 times faster than the container 4 with the minor component B 5. In this way, the container 4 of the minor component B compared to the exchangeable container 2 with the main component A need be exchanged and/or filled less often. In this way the user of a dispensing tool 1 acquires the ease of operation of a single-component system by having generally to exchange only the exchangeable container 2 with the main component A 3, and saves time and waste. In this connection a “single-component system” is a system in which, for example, a compound can be discharged from a container by a metering tool and in which the compound can perform its function without adding another compound, for example a minor component, by the metering tool.

The smallest expulsion delivered by the dispensing tool, hereinafter also called a pulse, of the main component A into the mixer 6 corresponds, for example, to a volume of 1000 mm3 (or lesser or greater). Accordingly the regulation of the expulsion of the minor component B 5 into the mixer 6 should allow expulsion with a volume of, for example, 20-30 mm3 (or lesser or greater).

The expulsion of the minor component B 5 can be regulated by a metering unit 8 which is located between the container 4 of the minor component B 5 and the mixer 6. This metering unit 8 is used, for example, when the expelling device 71, 72 for the container 4 of the minor component B does not satisfy the specifications for the expulsion pressure and/or the expulsion amount of the minor component B into the mixer. This can be dictated for example after pressing of minor component B. Furthermore metering of the expulsion of the minor component B into the mixer by the expelling device 71, 72 could involve a durable mechanism of the expelling device, for example a large and heavy mechanical gear train. Furthermore the expelling device 71, 72 would have to be able to execute very small feed rates. One possible feed rate for a container 4 of the minor component B 5 with an exemplary diameter of 25 mm would be, for example, 0.25 mm/s or lesser or greater. Furthermore, stick-slip effects, such as when the expelling device 71, 72 has a piston 14, can have an adverse effect on the precision of expulsion of the minor component B into the mixer since each time the dispensing tool 1 is turned on and off the container would have to be loaded or unloaded again, each time the adhesive friction on the piston 14 would have to be bridged; this would lead to inaccurate metering. Furthermore a metering unit 8 can prevent backflow of the minor component B and thus contribute to tightness and durability of the expulsion of the minor component B.

Furthermore a metering unit 8 can allow great flexibility in the choice of the amount and type of the minor component B used. By regulating the amount of expelled minor component B 5 relative to the main component A 3 the properties of the mixture of A and B can be set, and by regulating the expulsion pressure, minor components B with different volumes and viscosities can be used. In this way variations of the properties of the component due to pressure fluctuations can be compensated.

The metering unit 8 is, for example, a metering pump. One possible metering pump is the gear pump or internal gear pump. An advantage of this type can include the proven, widespread technology and the circumstance that this system is self-sealing. Furthermore the possibility of additional pressure build-up proceeding from an additional drive for the gears can be advantageous. For gears with an exemplary diameter of 15 mm and an exemplary number of teeth of 30, pulses with volumes of, for example, 2-3 mm3 are possible.

Ball meter pumps are known and for example are described in U.S. Pat. No. 5,850,946. The system can act in a self-sealing manner and pulses with volumes of, for example, 2-3 mm3 are possible.

Another system is the reciprocating pump which is also a proven, widespread technology and enables pulses with volumes of, for example, 20-30 mm3. Furthermore this system enables generation of very high pressures.

The system of screws can allow conveyance of highly viscous media and can be very resistant to material wear.

Another system is the hose pump or peristaltic pump which allows pulses with volumes of, for example, 20-30 mm³ and is characterized by a low tendency to fouling and simple maintenance, and the lobed rotor pump.

For example, the metering unit 8 is a reciprocating pump or a gear pump, such as a gear pump.

It can furthermore be advantageous if, for example, the metering unit 8 has a device for counting pulses, for example the gear revolutions or strokes. Furthermore the device for counting pulses can have a function for resetting the counter to zero when a new container is inserted, and a display, for example a row of LEDs, for visualization of counting.

The expelling device 71, 72 can be any type of device which is able to move the main component A 3 from the exchangeable container 2 and/or the minor component B 5 from the container 4 into the mixer 6.

For example, the expelling device 71, 72 is able to achieve a pressure of, for example, 5-15 bar, especially 8-12 bar in the mixer 6. It can be furthermore advantageous if the dispensing tool 1 has support structures for the container which take into account the extrusion forces of the expelling device 71, 72.

The dispensing tool 1 for each container can have its own expelling device 71, 72. In this way the use of a complex gear train can be avoided.

It can be furthermore advantageous that at least one expelling device 71, 72 is driven manually and/or hydraulically and/or pneumatically and/or mechanically and/or electrically, for example, by gas pressure and/or spring tension and/or by a motor. For example, at least one expelling device 71, 72 can be operated by a motor.

The expelling device 71 for the exchangeable container 2 of the main component A 3 can be an expelling device which is driven by a motor, such as an electric motor 16, and comprises a rack 15 with a piston 14. The driving by means of a motor has the advantage of a proven technology and high acceptance in the sector. Furthermore it allows direct extrusion of the main component A and high extrusion forces up to 15 bar and controlled expulsion. The combination of the rack 15 with a clutch moreover allows the piston 14 to be moved back and forth quickly; this can be advantageous especially when, for example, the container is changed.

Moreover the rack 15 can be used for visual position detection of the piston 14 and thus for display of the remaining volume of the main component A 3. Additional position detection via a sensor can however be advantageous.

Various systems are suitable as the expelling device 72 for the container 4 of the minor component B 5.

A system can be advantageous which is driven by spring tension. Exemplary advantages of this system are low maintenance effort and low weight.

To display the remaining volume of minor component B, indirect measurement via the metering unit 8 is suitable, for example by means of the device for counting the pulses, as was mentioned above.

For example, at least one of the containers is selected from the group consisting of a cylindrical receptacle with a movable piston, bags, bags with form fit and bags surrounded by a receptacle with a hard outer jacket.

A cylindrical receptacle with movable piston offers an exemplary advantage that supporting of the container is unnecessary and that the connection and removal of the container are simple. Furthermore under certain circumstances it can be reloaded.

A bag or a bag with form fit can store the components in a flexible film. The film can be bonded or mechanically crimped. This system can be economical and produce little scrap.

A receptacle with a hard outer jacket stores the component in a flexible bag. The bag is surrounded by a fixed outer jacket with high inherent stability, such as a polyethylene bag, an aluminum/plastic composite material, a cardboard container and the Tetra-Pak or a metal or plastic receptacle. For example, in the BARRIER PRESSURE PACK (Nussbaum Lichtenau GmbH, Germany) an aluminum inner bag is surrounded by an aluminum outer jacket. Between the inner bag and outer jacket is a propellant which expels the contents of the bag with gas pressure in this system.

The container 4 of the minor component B 5 can be an exchangeable container or not. If the container 4 is a bag with a fixed outer jacket, such as a BARRIER PRESSURE PACK, the container 4 after it is emptied can be removed from the dispensing tool 1 and can be replaced by a new container 4.

An advantage of this approach can be that the container 4 in this case has its own expelling device 72 which in the case of a gas pressure-driven expelling device has a low weight.

The container 4 of the minor component B 5 can be a refillable container or not. If the container 4 is a cylindrical receptacle with movable piston, the container 4 can be refilled. For refilling purposes the container 4, when for example it is an exchangeable refillable container, can be removed from the dispensing tool 1, and can be filled with minor component B 5 outside of the dispensing tool 1. But it is also possible to leave the container 4 in the dispensing tool 1 for refilling and to fill the container 4 via a device for refilling 9 of the container of the minor component B.

As mentioned above, the ratio of the volume of the minor component B 5 to the volume of the main component A 3 is, for example, 1:2-1:100, especially 1:10-1:90, preferably, for example, 1:40-1:75 and the exchangeable container 2 with the main component A 3 can be emptied, for example, 0.5-30, preferably, for example, 3-20, especially 5-12 times faster than the container 4 with the minor component B 5. In this way, for example, 5-12 containers 2 with the main component A are emptied and can be exchanged before the container 4 with the minor component B is emptied.

This can be advantageous because the container 4 with the minor component B in contrast to the exchangeable container 2 with the main component A need be exchanged less often. The user of the dispensing tool thus saves time and has the same convenience as in the use of a single-component compound. Furthermore in this way much less waste is produced. “Single-component compound” is defined in this connection as a compound which is, for example, discharged from a container by a metering tool and which can perform its function without adding another compound, for example a minor component, by the metering tool.

For example, the main component A 3 and/or the minor component B 5 is a pasty substance, such as the components A 3 and B 5 are components of adhesive compositions and/or sealant compositions.

The minor component B 5 is, for example a compound which reacts with the main component A 3, can lead to polymerization of the main component A, for example by initiation or acceleration, and to final hardening of the main component A. “Polymerization” is defined in this document as some kind of conversion of low molecular compounds (monomers, oligomers, prepolymers) into high-molecular compounds (polymers, macromolecules, polymerizates) and comprises polyaddition and polycondensation.

The main component A 3 is, for example, a cement and the minor component B 5 is a setting accelerator.

Mixers 6 are, for example, devices which can mix two or more flows of flowable substances or components into a completely or partially mixed common flowable mass flow. These mixers can be disposed of or purified after use and repeatedly re-used.

These mixers 6 can be used both for the essentially homogeneous mixing of the components and also for layered mixing-in of the components.

The mixer 6 can be static mixers in which mixing takes place by repeated division of the material strand, as well as dynamic mixers in which the processed components are repeatedly divided or even swirled by means of a movable element.

Static mixers such as described for example in WO 02/32562 A1 which do not have moving parts can be especially suitable for mixing of substances with low viscosity.

For example, for mixing of highly viscous substances, dynamic mixers can be used with a rotor which is pivotally located in the mixing chamber into which the substances to be mixed are introduced. Mixing devices of this type are described for example in EP 1106243 B1. The use of dynamic mixers can be advantageous in that by driving the dynamic mixer an additional pressure build-up is possible, in this way the necessity of a separate drive of the metering unit 8 can be eliminated.

For example, mixers and application syringes form one component.

For example, the dispensing tool 1 is portable; this allows a large radius of use of the dispensing tool; thus it can be for example easily transported. Furthermore it can thus be more comfortably handled.

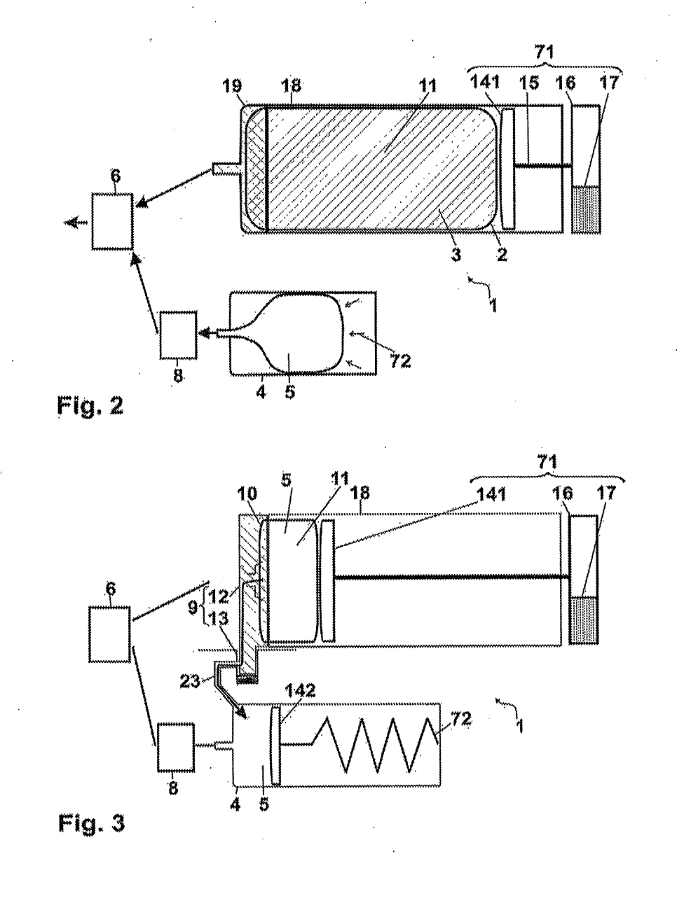

FIG. 2 shows one possible exemplary embodiment of a dispensing tool 1. The exchangeable container 2 with the main component A 3 includes a bag. The expelling device 71 for the exchangeable container 2 comprises a rack 15, a piston 141, an electric motor 16 for driving the rack 15, and a battery 17 for power supply to the electric motor 16.

Furthermore the exchangeable container 2 is surrounded by a support pipe 18 which ensures support of the container, such as when the exchangeable container 2 is a bag. The support pipe 18 is terminated on the end in the expulsion direction with a funnel 19 by which the main component A 3 is guided on the path to the mixer 6. On the end opposite the expulsion direction the support pipe 18 can be positively closed by the piston 141 by which the exchangeable container 2 is moved in the expulsion direction and the main component A is expelled from the exchangeable container 2.

The container 4 with the minor component B 5 can be an exchangeable container and can include a bag with a fixed outer jacket, such as a BARRIER PRESSURE PACK which has a gas pressure-driven expelling device 72. The container 4 can be removed from the dispensing tool 1 after it is emptied and can be replaced by a new container.

The minor component B 5 travels into the metering unit 8 which can be a gear pump.

In the mixer 6 main component A and minor component B are mixed with one another. For example, the mixer 6 is a dynamic mixer which is disposed of after use. This can be advantageous in that the driving of the gear pump is tapped from the driving of the dynamic mixer.

FIG. 3 shows another exemplary embodiment of a dispensing tool 1 which corresponds to the example shown in FIG. 2, but in contrast to the example shown in FIG. 2 the container 4 with the minor component B 5 is a refillable container and includes (e.g., consists of) a cylindrical container with movable piston 142.

The movable piston 142 is part of the expelling device 72 for the container 4 of the minor component B 5 which is driven by spring tension.

Furthermore the embodiment shown in FIG. 3 has a device for refilling 9 of the container 4 of the minor component B. The device for refilling 9 can draw the minor component B 5 via the container N 10 which is located at the site 11 which is intended for the exchangeable container 2 of the main component A 3. Since the volume of the container 4 of the minor component B as mentioned above is smaller than the volume of the exchangeable container 2 of the main compound A, the container N will be located at the site 11 intended for the exchangeable container 2 of the main component A 3, or on the support pipe 18. The type of container N corresponds, for example, to the type of exchangeable container 2, in this case the container is a bag. For expulsion of the minor component B from the container N for refilling the container 4, the same expelling device 71 can be used which is used for the container A. Since the expelling device 71 has an electric motor, during refilling it is possible to build up a large pressure which can be stored in the spring tension of the expelling device 72 for the container 4 of the minor component B and can be used to drive the expelling device 72.

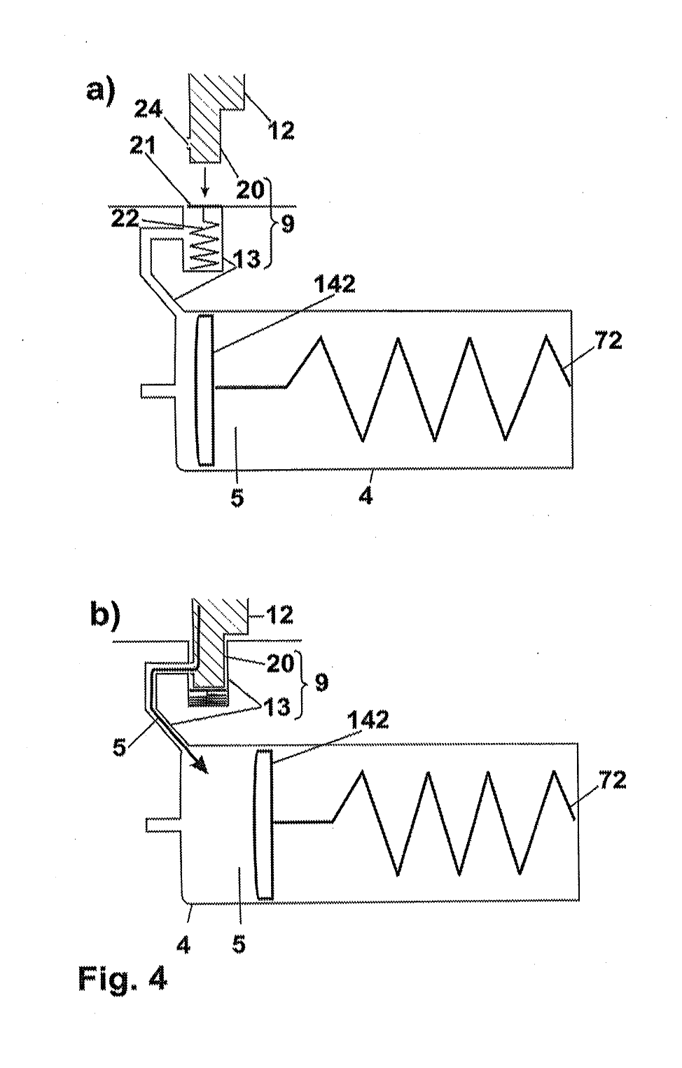

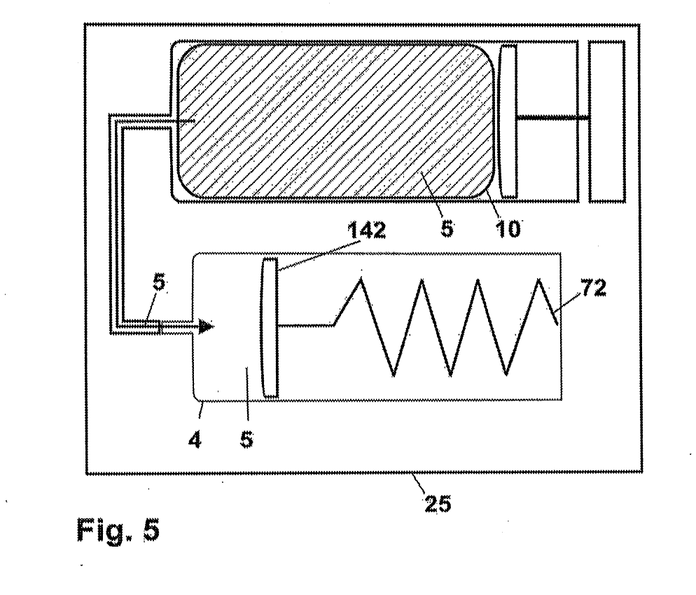

The device for refilling 9 of the container of the minor component B is shown more accurately in FIGS. 4a and 4b and comprises an adapter 12 which can open one access 13 to the container 4 of the minor component B 5 and routes the contents of the container N 10 to the access 13. The adapter 12 can take the place of the funnel 19 or is mounted in the expulsion direction in front of the funnel, so that there is no contamination of the funnel with the minor component B. The adapter 12 can have a pin 20 by which minor component B can be discharged and which can open the access 13 to the container 4 of the minor component B 5.

For example, the adapter 12 can be inserted into the funnel 19 and can be locked with a quarter-turn fastener, the pin 20 opening the access 13 as well by locking.

The access 13 can be closed when the exchangeable container 2 of the main composition A is located in the support pipe 18. The access 13 has a closure piece 21 which closes the access by a closing spring 22. By introducing the pin 20, the closure piece 21 which is supported on the closing spring 22 is pressed down and the access 13 is thus opened.

Upon expulsion of the container N minor component B can travel through the pin opening 24 into the transfer channel 23 and thus into the container 4 of the minor component B. The expelling device 72 is tensioned at the same time by filling. For example, the transfer channel 23 has a valve or another mechanism which allows the flow of material in the direction of the container 4, but prevents flow in the opposite direction.

In another exemplary embodiment of the dispensing tool 1 which is shown in FIG. 3, the dispensing tool 1 in contrast to the example shown in FIG. 2 has a container 4 which is a refillable and exchangeable container and includes a cylindrical container with movable piston 142.

The movable piston 142 is part of the expelling device 72 for the container 4 of the minor component B 5 which is driven by spring tension. For refilling of the container 4 with minor component B, the container 4 can be removed from the dispensing tool 1 and can be filled in an external filling station 25 with minor component B. This is shown in FIG. 5. At the same time the expelling device 72 of the container 4 can be tensioned by filling.

Furthermore the disclosure comprises a method for refilling of the container 4 of the minor component B 5 of a dispensing tool, as is described above for example with respect to FIG. 3, FIG. 4a, and FIG. 4b, and which comprise the following exemplary steps:
a) placing the container N 10 which contains minor component B 5 at the site 11 provided for the container 2 of the main component A 3;
b) expelling the minor component B 5 from the container N 10 into the access 13 to the container 4 of the minor component B 5; and
c) filling the container 4 of the minor component B 5 with minor component B 5 via the access 13.

The minor component B 5 is expelled from the container N 10 in step b) by the expelling device 71 of the main component A.

Of course the disclosure is not limited to the illustrated and described exemplary embodiments.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE NUMBER LIST

1 dispensing tool
2 exchangeable container of main component A
3 main component A
4 container of minor component B
5 minor component B
6 mixer
71 expelling device of main component A
72 expelling device of minor component B
8 metering unit
9 device for refilling of the container of the minor component B
10 container N
11 location intended for the container of the main component A
12 adapter
13 access
14 piston
141 piston of the expelling device 71
142 piston of the expelling device 72
15 rack
16 electric motor
17 battery
18 support pipe
19 funnel
20 pin
21 closing piece
22 closing spring
23 transfer channel
24 pin opening
25 external filling station for container of minor component B

What is claimed is:

1. Dispensing tool comprising:
an exchangeable container for a main component A and a container for a minor component B;
a mixer for the components A and B; and
at least one expelling device for at least one of the containers, for regulating expelling of at least one of the components A or B into the mixer independently of the other component B or A.

2. Dispensing tool as claimed in claim 1, comprising:
a metering unit for regulated expelling of the minor component B, the metering unit being located between the container of the minor component B and the mixer.

3. Dispensing tool as claimed in claim 2, wherein the metering unit is a metering pump.

4. Dispensing tool as claimed in claim 1, wherein a ratio of a volume of the minor component B to a volume of the main component A is 1:2-1:100.

5. Dispensing tool as claimed in claim 1, comprising:
a drive for the at least one expelling device for driving the expelling device by gas pressure and/or spring tension and/or by a motor.

6. Dispensing tool as claimed in claim 1, comprising:
an expelling device for each container.

7. Dispensing tool as claimed in claim 1, wherein at least one of the containers is selected from the group consisting of: a cylindrical receptacle with movable piston, a bag, a bag with form fit, and a bag surrounded by a receptacle with a hard outer jacket.

8. Dispensing tool as claimed in claim 1, wherein the dispensing tool is a portable device.

9. Dispensing tool as claimed in claim 1, in combination with the main component A and the minor component B, wherein the main component A and/or the minor component B is a pasty substance.

10. Dispensing tool as claimed in claim 1, in combination with the main component A and the minor component B, wherein the components A and B are components of adhesive compositions and/or sealant compositions.

11. Dispensing tool as claimed in claim 1, wherein the exchangeable container for the main component A is emptied 0.5-30 times faster than the container with the minor component B.

12. Dispensing tool as claimed in claim 1, wherein the container of the minor component B is an exchangeable container.

13. Dispensing tool as claimed in claim 1, wherein the container of the minor component B is a refillable container.

14. Dispensing tool as claimed in claim 13, wherein the dispensing tool is a device for refilling of the container for the minor component B.

15. Method for refilling the container of a minor component B of a dispensing tool having an exchangeable container for a main component A and a container for a minor component B; a mixer for the components A and B; and at least one expelling device for at least one of the containers, for regulating expelling of at least one of the components A or B into the mixer independently of the other component B or A, the method comprising:
a) placing a container N which serves as the container for minor component B at a site provided for the container of the main component A;
b) expelling a minor component B from the container N into an access to the container of the minor component B; and
c) filling the container of the minor component B with minor component B via the access, the minor component B being expelled from the container N in step b) by the expelling device of the main component A.

16. Dispensing tool as claimed in claim 2, wherein the metering pump is a reciprocating pump or a gear pump.

17. Dispensing tool as claimed in claim 1, wherein a ratio of a volume of the minor component B to a volume of the main component A is 1:40-1:75.

18. Dispensing tool as claimed in claim 1, wherein a ratio of a volume of the minor component B to a volume of the main component A is 1:10-1:90.

19. Dispensing tool as claimed in claim 1, wherein the exchangeable container for the main component A is emptied 3-20 times faster than the container with the minor component B.

20. Dispensing tool as claimed in claim 1, wherein the exchangeable container for the main component A is emptied 5-12 times faster than the container with the minor component B.
